(19) United States
(12) Patent Application Publication
(10) Pub. No.: US 2019/0346867 A1
(43) Pub. Date: Nov. 14, 2019

(54) PRESSURE CONTROL FOR GAS SYSTEM PAYBACK

(71) Applicant: CRITICAL SYSTEMS, INC., Boise, ID (US)

(72) Inventors: Thomas Britton, Boise, ID (US); Theodore Jones, Boise, ID (US)

(21) Appl. No.: 16/412,266

(22) Filed: May 14, 2019

Related U.S. Application Data
(60) Provisional application No. 62/671,121, filed on May 14, 2018.

(51) Int. Cl. G05D 16/20; G05D 7/06

(52) U.S. Cl. CPC G05D 16/2066; G01L 19/0015; G05D 16/2093; G05D 7/0629

(57) ABSTRACT

Embodiments described herein are directed to regulating pressure and/or fluid flow within a system. In one scenario, a system for regulating pressure includes a controller, a pneumatic pressure regulator with a dome that adjusts pressure within the system, a current-to-pneumatic converter that converts an electrical current signal to a pneumatic pressure signal, and a pressure transducer. The controller receives an outlet pressure signal from the pressure transducer indicating a current level of system pressure, compares the current system pressure level to a desired system pressure level and, upon determining that the current system pressure level is above or below the desired system pressure level, sends an electrical current signal to the current-to-pneumatic converter that converts the electrical current signal to a pneumatic pressure signal that is sent to the dome of the pneumatic pressure regulator to raise or lower system pressure to the desired system pressure level.

### CROSS-REFERENCE TO RELATED APPLICATIONS

This application claims priority to and the benefit of U.S. Provisional Patent Application Ser. No. 62/671,121, entitled “Pressure Control for Gas System Payback,” filed on May 14, 2018, which application is incorporated by reference herein in its entirety.

### BACKGROUND

Gas cabinets are often used in industry to control the flow of gas from a source such as a gas cylinder to a destination such as a piece of industrial equipment. Traditional gas cabinets often use spring loaded regulators to control cylinder pressure, keeping the pressure to a usable level. Compressed gases may have initial cylinder pressures of up to 3,000 pounds per square inch (psi), and the cylinder may have a change-out pressure 200-300 psi. Thus, when a cylinder is full of gas, the pressure is 10× (or more) higher than when the cylinder is eventually changed out.

A phenomenon called “Supply Pressure Effect” (SPE) occurs in pressure regulators where the outlet pressure rises as the cylinder pressure drops. This is because the regulator spring produces a constant force on a diaphragm, which pushes down on a poppet, opening the flow path through the regulator. To counter this spring force, the gas pressure pushes the regulator open by applying pressure to the poppet and under the diaphragm. As the cylinder pressure decays over time, less force is applied to the poppet, and the spring above the diaphragm continues to open the regulator, increasing the outlet pressure.

Depending on the regulator's required flow rate, the rise in pressure can be significant. The (SPE) may be stated in pressure rise per 100 psi loss of pressure in the cylinder. The (SPE) can vary from a low of 0.25 psi for low flow regulators to over 3.5 psi for higher flow regulators. Because of this, a cylinder with a starting pressure of 2,200 psi and a final change-out pressure of 200 psi could see the outlet pressure rise in the system anywhere from 5 to 70 psi. This rise in outlet pressure can play havoc with downstream equipment, alarms, set points, and potential tool shutdowns.

To minimize the supply pressure effect, regulators are sized to deliver flow rates as close as possible to the process tool's requirements, at the desired pressure when the cylinder is full. The regulator must also deliver adequate flow when the gas cylinder is low on gas. As the cylinder pressure decays to a certain point, the flow is not sufficient for the needs of the process, and the cylinder is changed out, even though it still contains a significant amount of gas. This may result in two potential expenses for the gas cabinet owner: first, a certain amount of gas, which was paid for, is returned to the supplier in the gas cylinder. In some cases, this can be up to 20% of the cylinder's contents. The cost of this wasted gas can be significant. Secondly, gas suppliers often charge to dispose of this residual gas since it is usually hazardous. Accordingly, many problems exist with current gas cabinets.

### BRIEF SUMMARY

Embodiments described herein are directed to regulating pressure and/or fluid flow within a system. In one embodiment, a system for regulating pressure includes the following: a controller, a pneumatic pressure regulator that includes a dome configured to adjust pressure within the system, a current-to-pneumatic converter configured to convert an electrical current signal to a pneumatic pressure signal, and a pressure transducer arranged downstream from the pneumatic pressure regulator. The controller receives an outlet pressure signal from the pressure transducer indicating a current level of system pressure, compares the current system pressure level to a specified desired system pressure level and, upon determining that the current system pressure level is above or below the desired system pressure level, sends an electrical current signal to the current-to-pneumatic converter that converts the electrical current signal to a pneumatic pressure signal that is sent to the dome of the pneumatic pressure regulator to raise or lower system pressure to the desired system pressure level.

In some examples, the system may include a gas cabinet for regulating gas pressure. The gas cabinet may include at least one gas input line and at least one gas output line. The system may form a control loop where outlet pressure from the gas cabinet is kept at a substantially steady pressure level. The control loop may maintain the substantially steady pressure level regardless of pressure level remaining in a gas cylinder connected to the gas input line. Additionally or alternatively, the control loop may maintain the substantially steady pressure level regardless of a speed of consumption by one or more process tools connected to the gas output line. The control loop may also maintain a substantially steady pressure level until supply pressure drops below a specified minimum supply pressure.

In some examples, the gas cabinet may include regulators sized for a desired system pressure level. The controller may also send the electrical current signal to the current-to-pneumatic converter upon determining that the pressure level is above the desired system pressure level by at least a specified amount or is below the desired system pressure level by at least a specified amount. In some examples, the pressure transducer may be a pressure switch.

In another embodiment, a system is provided for regulating flow. The system includes a controller, a pneumatic pressure regulator that includes a dome configured to increase pressure or relieve pressure within the system, a current-to-pneumatic converter configured to convert an electrical current signal to a pneumatic pressure signal, and a flow meter arranged downstream from the pneumatic pressure regulator. The controller receives a flow signal from the flow meter indicating a current level of system flow, compares the current system flow level to a specified desired system flow level and, upon determining that the current system flow level is above or below the desired system flow level, sends an electrical current signal to the current-to-pneumatic converter that converts the electrical current signal to a pneumatic pressure signal that is sent to the dome of the pneumatic pressure regulator to raise or lower system flow level to the desired system flow level.

In some examples, the system includes or is incorporated within a gas cabinet for regulating gas flow through gas input lines and through gas output lines. In some examples, at least one of the gas input lines is connected to a gas cylinder. In some examples, at least one of the gas output lines is connected to a process tool. The system may form a control loop where outlet gas flow from the gas cabinet is kept at a substantially steady system flow level. The control loop may maintain the substantially steady system flow level regardless of pressure level remaining in any gas cylinders connected to the gas input line. The control loop may maintain the substantially steady system flow level regardless of a speed of consumption by the process tools connected to the gas output line.

A method for regulating pressure may also be provided, which includes receiving an outlet pressure signal from a pressure transducer indicating a current level of system pressure, comparing the current system pressure level to a specified desired system pressure level and, upon determining that the current system pressure level is above or below the desired system pressure level, sending an electrical current signal to a current-to-pneumatic converter that converts the electrical current signal to a pneumatic pressure signal that is sent to a dome element of a pneumatic pressure regulator to raise or lower system pressure to the desired system pressure level. The method may further include maintaining the desired system pressure level to within a specified acceptable deviation in system pressure level. These method steps may be performed by an embedded controller in a gas cabinet.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a system architecture in which embodiments described herein may operate including regulating pressure within a system.

FIG. 2 illustrates an alternative embodiment of a controller architecture for regulating pressure within a system.

FIG. 3 illustrates an embodiment in which a pressure regulating system is implemented in a gas cabinet.

FIG. 4 illustrates a controller architecture in which embodiments described herein may operate including regulating fluid flow within a system.

FIG. 5 illustrates a flowchart of an example method for regulating pressure and/or fluid flow within a system.

### DETAILED DESCRIPTION

Embodiments described herein are directed to regulating pressure and/or fluid flow within a system. In one embodiment, a system for regulating pressure includes the following: a controller, a pneumatic pressure regulator that includes a dome configured to adjust pressure within the system, a current-to-pneumatic converter configured to convert an electrical current signal to a pneumatic pressure signal, and a pressure transducer arranged downstream from the pneumatic pressure regulator. The controller receives an outlet pressure signal from the pressure transducer indicating a current level of system pressure, compares the current system pressure level to a specified desired system pressure level and, upon determining that the current system pressure level is above or below the desired system pressure level, sends an electrical current signal to the current-to-pneumatic converter that converts the electrical current signal to a pneumatic pressure signal that is sent to the dome of the pneumatic pressure regulator to raise or lower system pressure to the desired system pressure level.

In some examples, the system may include a gas cabinet for regulating gas pressure. The gas cabinet may include at least one gas input line and at least one gas output line. The system may form a control loop where outlet pressure from the gas cabinet is kept at a substantially steady pressure level. The control loop may maintain the substantially steady pressure level regardless of pressure level remaining in a gas cylinder connected to the gas input line. Additionally or alternatively, the control loop may maintain the substantially steady pressure level regardless of a speed of consumption by one or more process tools connected to the gas output line. The control loop may also maintain a substantially steady pressure level until supply pressure drops below a specified minimum supply pressure.

In some examples, the gas cabinet may include regulators sized for a desired system pressure level. The controller may also send the electrical current signal to the current-to-pneumatic converter upon determining that the pressure level is above the desired system pressure level by at least a specified amount or is below the desired system pressure level by at least a specified amount. In some examples, the pressure transducer may be a pressure switch.

In another embodiment, a system is provided for regulating flow. The system includes a controller, a pneumatic pressure regulator that includes a dome configured to increase pressure or relieve pressure within the system, a current-to-pneumatic converter configured to convert an electrical current signal to a pneumatic pressure signal, and a flow meter arranged downstream from the pneumatic pressure regulator. The controller receives a flow signal from the flow meter indicating a current level of system flow, compares the current system flow level to a specified desired system flow level and, upon determining that the current system flow level is above or below the desired system flow level, sends an electrical current signal to the current-to-pneumatic converter that converts the electrical current signal to a pneumatic pressure signal that is sent to the dome of the pneumatic pressure regulator to raise or lower system flow level to the desired system flow level.

In some examples, the system includes or is incorporated within a gas cabinet for regulating gas flow through gas input lines and through gas output lines. In some examples, at least one of the gas input lines is connected to a gas cylinder. In some examples, at least one of the gas output lines is connected to a process tool. The system may form a control loop where outlet gas flow from the gas cabinet is kept at a substantially steady system flow level. The control loop may maintain the substantially steady system flow level regardless of pressure level remaining in any gas cylinders connected to the gas input line. The control loop may maintain the substantially steady system flow level regardless of a speed of consumption by the process tools connected to the gas output line.

A method for regulating pressure may also be provided, which includes receiving an outlet pressure signal from a pressure transducer indicating a current level of system pressure, comparing the current system pressure level to a specified desired system pressure level and, upon determining that the current system pressure level is above or below the desired system pressure level, sending an electrical current signal to a current-to-pneumatic converter that converts the electrical current signal to a pneumatic pressure signal that is sent to a dome element of a pneumatic pressure regulator to raise or lower system pressure to the desired system pressure level. The method may further include maintaining the desired system pressure level to within a specified acceptable deviation in system pressure level. These method steps may be performed by an embedded controller in a gas cabinet.

Embodiments described herein may implement various types of controllers, processors, embedded computing systems or other types of computing systems. These computing systems may include, without limitation, application-specific integrated circuits (ASICs), field-programmable gate arrays (FPGAs), complex programmable logic devices (CPLDs), systems-on-a-chip, or other special purpose processors. The computing systems may also include, without limitation, desktop or mainframe computers, laptop computers, tablet computers, wearable devices, mobile phones, electronic appliances, and other types of computing systems.

As used herein, the term “computing system” includes any device, system, or combination thereof that includes at least one processor, and a physical and tangible computer-readable memory capable of having thereon computer-executable instructions that are executable by the processor. A computing system may be distributed over a network environment and may include multiple constituent computing systems (e.g. a cloud computing environment). In a cloud computing environment, program modules may be located in local and/or remote memory storage devices.

As described herein, a computing system may also contain communication channels that allow the computing system to communicate with other message processors over a wired or wireless network. Such communication channels may include hardware-based receivers, transmitters or transceivers, which are configured to receive data, transmit data, or both. Embodiments described herein may also include physical computer-readable media for carrying or storing computer-executable instructions and/or data structures. Such computer-readable media can be any available physical media that can be accessed by a general-purpose or special-purpose computing system.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

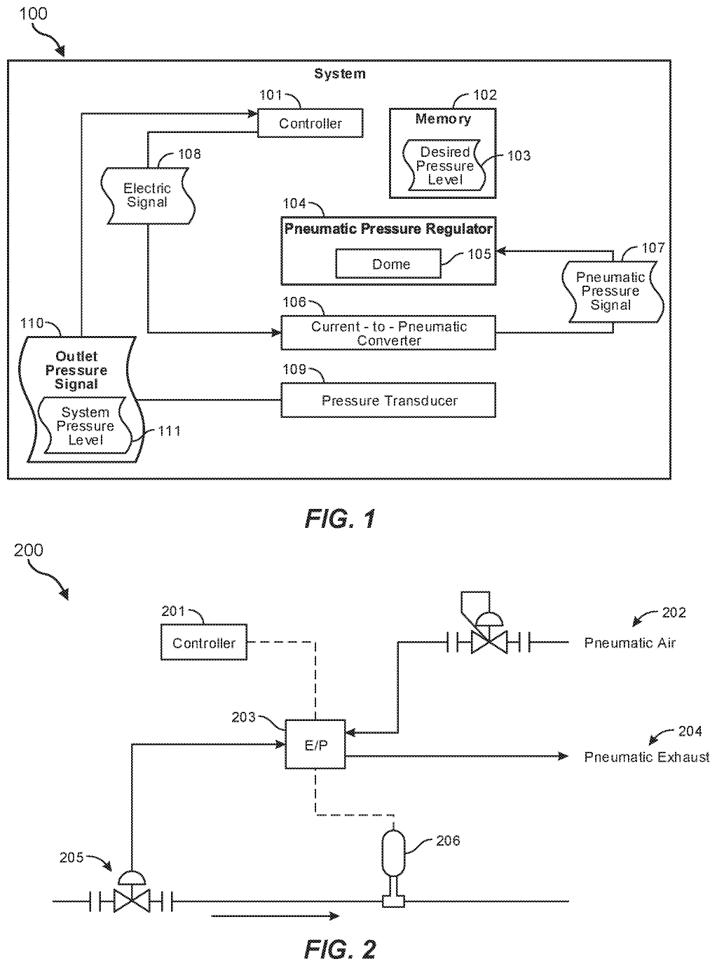

The following will provide, with reference to FIGS. 1-5, detailed descriptions of how and when user pressure and flow are recorded, and how those reactions are presented to other users. FIG. 1, for example, illustrates a system 100 in which many of the embodiments described herein may operate. The system 100 may include a controller 101. The controller 101 may be any type of processing device configured to process software instructions, including ASICs, FPGAs, CPLDs, systems-on-a-chip, or other processing devices. The controller 101 may be configured to access memory 102. The memory 102 may include local and/or remote data stores accessible via a computer network. The memory 102 may store a desired pressure level 103 for the system. The desired pressure level may indicate an exact pressure level or a range of pressure levels within which the system 100 is to operate. 101.

The system 100 may also include hardware components including a pneumatic pressure regulator 104, a current-to-pneumatic converter 106, and a pressure transducer 109. Other hardware components and/or software components may be implemented within system 100. The system may, for example, include program modules for performing different functions. The program modules may be hardware-based, software-based, or may include a combination of hardware and software. Each program module may use or represent computing hardware and/or software to perform specified functions, including those described herein below.

For example, in some embodiments, the controller 101 may be communicatively connected to a communications module. The communications module may include any wired or wireless communication means that can receive and/or transmit data to or from other computer systems. These communication means may include radios including, for example, a hardware-based receiver, a hardware-based transmitter, or a combined hardware-based transceiver capable of both receiving and transmitting data. The radios may be WIFI radios, cellular radios, Bluetooth radios, global positioning system (GPS) radios, or other types of radios. Such a communications module may be configured to interact with databases, mobile devices (such as mobile phones or tablets), embedded systems, or other types of computing systems.

Thus, the controller 101 may communicate with components and modules within the system 100, as well as components and/or modules that are external to the system 100. In some embodiments, the controller 101 may communicate with the current-to-pneumatic converter 106, for example, sending an electric signal 108 that may indicate that pressure is to be increased or decreased. The current-to-pneumatic converter 106 may be configured to convert an electrical current signal to a pneumatic pressure signal 107. This pneumatic pressure signal 107 may be sent to the pneumatic pressure regulator 105, which includes a dome 105 configured to adjust pressure within the system. The pneumatic pressure regulator 104 may then activate or actuate the dome 105 to increase or decrease pressure within the system.

In one embodiment, the controller 101 of system 100 may receive an outlet pressure signal 110 from the pressure transducer 109 indicating a current level of system pressure 111. Upon receiving this outlet pressure signal 110, the controller compares the current system pressure level to a specified desired system pressure level 103. This desired system pressure level 103 may be set by a worker, manager, manufacturer, or other individual. The desired system pressure level 103 may indicate the pressure level that is to be maintained between one or more of the components of the system 100 including any gas lines in to the system, gas lines out of the system, the pneumatic pressure regulator 104 and the pressure transducer. At least in some cases, the system pressure level 111 may be different when measured at different components.

Accordingly, in such cases, the desired pressure level 103 may specify where the pressure measurement is to be taken. In some embodiments, the pressure transducer 109 detects the current system pressure level 111 and generates the outlet pressure signal 110 indicating to the controller 101 that the controller 101 is to increase or decrease system pressure using the pneumatic pressure regulator 104. In some cases, the pressure transducer 109 may be a pressure switch or other actuator that is capable of reading or responding to a given pressure level and generating an outlet pressure signal.

Accordingly, upon determining that the current system pressure level 111 is above or below the desired system pressure level 103, the controller 101 may send an electrical current signal 108 to the current-to-pneumatic converter 106 that converts the electrical current signal to a pneumatic pressure signal 107 that is sent to the dome 105 of the pneumatic pressure regulator 104 to raise or lower system pressure to the desired system pressure level. Thus, in cases where a pneumatic pressure regulator is used, the pneumatic pressure signal 107 will indicate how the dome 105 is to be operated to increase or decrease the system pressure level 111. In cases where another (non-pneumatic) type of pressure regulator is used, the controller may generate a control signal that goes directly to the pressure regulator and applies the appropriate changes to the dome 105 to increase or decrease pressure depending on what was indicated in the outlet pressure signal 110.

FIG. 2 illustrates a system 200 which may be similar to or the same as system 100 of FIG. 1. In system 200, a controller 201 is in communication with a current-to-pneumatic converter (E/P) 203. The controller may send electric signals to the current-to-pneumatic converter 203 upon determining that the pressure is too high within the system in general or is too high on any given line within the system 200. In some cases, the system 200 may be implemented in a gas cabinet or may itself be a gas cabinet. The gas cabinet may be implemented to regulate pressure and/or flow within a system. For example, many industrial devices use gases when manufacturing products. Semiconductor chips, for example, are manufactured using a variety of highly toxic gases. These gases may be heavily regulated and controlled to be released in proper amounts. Each piece of industrial equipment may be designed to receive the gas at a certain pressure.

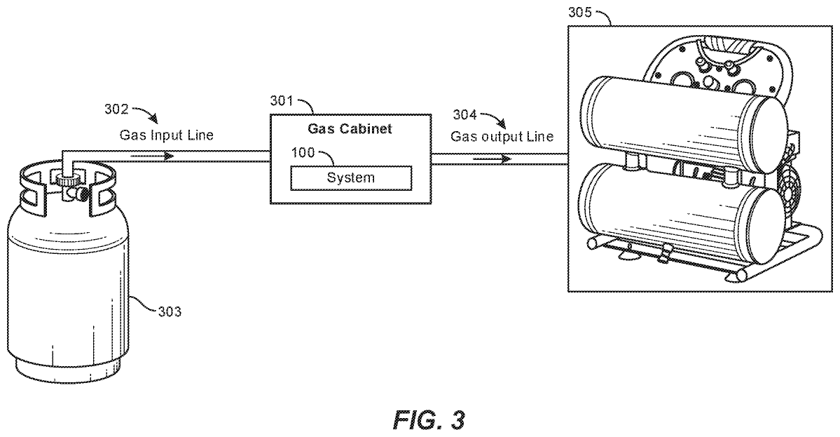

For example, as shown in FIG. 3, a gas cabinet 301 (which may include system 100 of FIG. 1 or system 200 of FIG. 2) may be positioned between a gas supply (e.g., gas cylinder 303) and a gas consumer (e.g., industrial equipment 305). The gas cabinet 301 receives gas from the source through a gas input line 302. The gas cabinet 301 then regulates the flow and pressure of the gas while delivering the gas via a gas output line 304 to the gas consumer. It will be understood that the gas cabinet may receive gas from substantially any source including one or more gas cylinders 303, gas storage tanks or other gas containers. These containers may be pressurized, in some cases to around 3,000 psi (pounds per square inch). Over time, as the gas in the container is used up, the pressure within the container will decrease. This drop in pressure within the container may result in a drop in pressure along the gas input line 302. The gas cabinet 301 may thus be designed to increase the pressure before passing the gas to the gas output line. Indeed, as noted above, the industrial equipment 305 may operate most efficiently when the pressure in the gas output line 304 is at a specified pressure or within a specified pressure range.

Accordingly, as the gas pressure in the supply line 302 decreases, the controller 201 may receive inputs from a pressure transducer 205 indicating the decline in pressure. The controller may determine that the current system pressure level is too low and may send an electrical current signal to the current-to-pneumatic converter 203 that converts the electrical current signal to a pneumatic pressure signal 202 that is sent to the dome 206 of the pneumatic pressure regulator to raise or lower system pressure to a specified system pressure level. Excess pressure may also be relieved via the pneumatic exhaust 204.

Accordingly, in this manner, the system 200 forms a control loop where outlet pressure from the gas cabinet 301 is kept at a substantially steady pressure level, even as input pressure declines. Initially, due to the relatively high pressure in the input line 302, the gas cabinet 301 may decrease the pressure to maintain a substantially steady pressure level in the gas output line 304. Then, as the pressure in the gas input line 302 drops, the gas cabinet 301 may increase the pressure level to maintain the steady pressure level in the gas output line 304. Thus, the gas cabinet 301 may maintain a steady output pressure in the gas output line 304 regardless of the pressure level remaining in the gas cylinder 303 (or other gas source) connected to the gas input line 302. This control loop may also maintain a steady pressure level regardless of the speed of consumption by the industrial tools 305 connected to the gas output line 304. Accordingly, even if the industrial tool's demand for gas fluctuates over time, and if the pressure in the gas output line 304 varies along with the demand, the control loop may ensure that the system pressure level stays at a specified pressure, or within a certain pressure range.

Once the gas supply 303 begins to run out, the supply pressure may drop below a specified minimum pressure level. The control loop within the system 100 may be configured to maintain a steady pressure level until supply pressure drops below the specified minimum supply pressure. Once the minimum supply pressure is no longer being met, the gas supply container will need to be replaced. The embodiments herein, however, may allow more of the gas in the container to be used than in traditional systems. By removing pressure when the gas cylinder 303 is full, and by adding pressure when the gas cylinder is near empty, the systems herein may allow higher pressure cylinders to be used, and may also allow more of the gas to be used before having to replace the cylinders.

In some embodiments, the gas cabinet 301 may include regulators that are sized for a specific system pressure level. Thus, for example, if a user specifies a desired pressure level 103 for the system 100 of FIG. 1, the system may be equipped with pneumatic pressure regulators that are sized to handle the specified pressure level 103. Accordingly, smaller systems that handle lower pressures may be equipped with a smaller regulator, and larger systems that handle higher pressures may be equipped with a larger regulator capable of handling the higher pressures.

In some cases, the controller in the gas cabinet 301 may be configured to take no action until the system pressure level is sufficiently above or below the desired pressure level 103. For example, the controller 101 may be configured to send the electrical current signal 108 to the current-to-pneumatic converter 106 upon determining that the pressure level 111 is above the desired system pressure level 103 by at least a specified amount or is below the desired system pressure level by at least a specified amount. The range may be plus or minus 10 psi, 20 psi, 50 psi, 100 psi, or some other range. Once outside of this range, the controller 101 may then take action to raise or lower the system pressure. Then, once the pneumatic pressure regulator has actuated the dome 105 to increase or decrease system pressure to within the specified range, the controller may idle and wait for a new outlet pressure signal indicating that the system pressure needs to be altered.

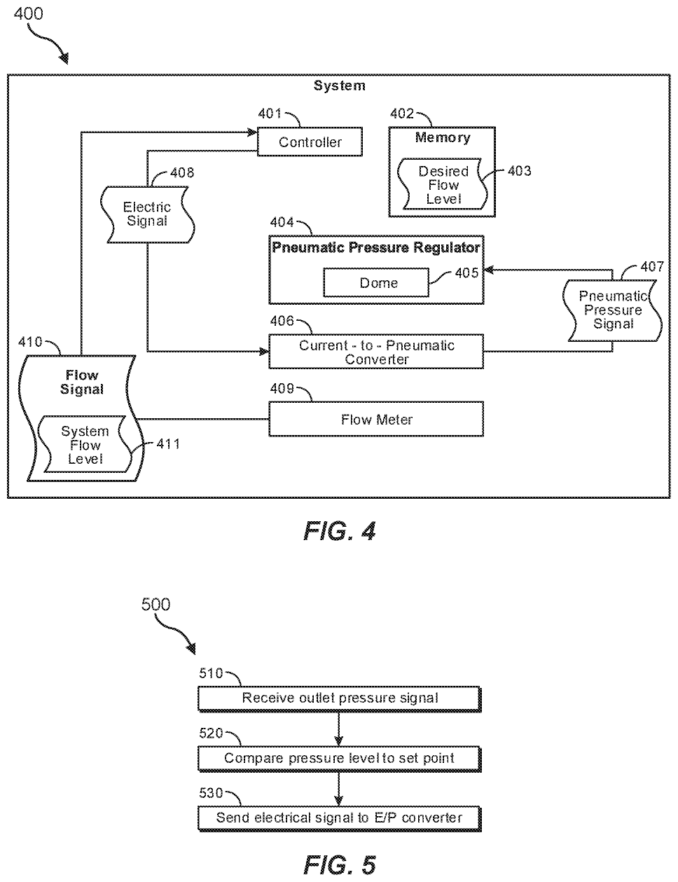

The embodiments herein may not only regulate pressure within a system, but they may (additionally or alternatively) regulate flow within the system. For example, as shown in FIG. 4, a system 400 may be provided for regulating flow. The system 400 may include a controller 401, a pneumatic pressure regulator 404 that includes a dome 405 configured to increase flow or decrease flow within the system, a current-to-pneumatic converter 406 configured to convert an electrical current signal 408 to a pneumatic pressure signal 407, and a flow meter 409 arranged downstream from the pneumatic pressure regulator 404.

The controller 401 may receive a flow signal 410 from the flow meter 409 indicating a current level of system flow 411. The controller 401 may then compare the current system flow level 411 to a specified desired system flow level 403 stored in memory 402. If the controller 401 determines that the current system flow level 411 is above or below the desired system flow level 403, the controller may send an electrical current signal 408 to the current-to-pneumatic converter 406 that converts the electrical current signal to a pneumatic pressure signal 407. That pneumatic pressure signal may then be sent to the dome 405 of the pneumatic pressure regulator 404 to raise or lower system flow level to the desired system flow level 403.

As with system pressure, the system flow level may fluctuate as a gas supply container changes in pressure over time. Initially, when the container (e.g. 303 of FIG. 3) is full and is highly pressurized, the gas may flow at a higher rate. Then, as the container runs lower on gas, the pressure may be reduced, causing the gas to flow more slowly. Accordingly, the controller 401, upon determining that the gas flow rate is too high or too low within the system 400, or on a specific gas in or gas out line, may generate an electric signal 408 and send that signal to a current-to-pneumatic converter 406. This converter converts the electric current signal 408 into a pneumatic pressure signal 407 that is understood by the pneumatic pressure regulator 404. The pneumatic pressure regulator 404 may then regulate the flow of gas through the system (or through specific gas lines in the system) by actuating the dome 405 to increase or decrease the flow rate.

As with the systems 100 and 200, the system 400 may be incorporated within or may itself be a gas cabinet. The gas cabinet may be used to regulate gas flow through gas input line and gas output lines. As shown in FIG. 3, the gas input line 302 may be connected to a gas cylinder, and the gas output line may be connected to a process tool or other industrial tool 305. The system 400 may forms a control loop where outlet gas flow from the gas cabinet 301 is kept at a substantially steady system flow level, or at least within a specified flow range. The control loop may be configured to maintain this steady system flow level regardless of the pressure level remaining in the gas cylinder 303. The control loop may also be configured to maintain the steady system flow level regardless of the speed of consumption by the industrial manufacturing tools 305.

Accordingly, the systems above may provide a feedback control loop that ensures that a substantially constant pressure or flow rate is maintained. This feedback control loop may be referred to as a “closed loop pressure control.” This closed loop pressure control (or flow control) may be provided in a cylinder gas cabinet. A controller (e.g. 101 of FIG. 1) may receive an outlet pressure signal 110 from a transducer downstream of the pressure regulator 104. This signal is compared against the required pressure (e.g., 103) that the user set in the controller. The controller sends a signal to the current-to-pneumatic converter 106 that converts a current milliamp signal to a pneumatic pressure signal 107 that is sent to the dome 105 of the process regulator 104.

This arrangement of components may provide a highly accurate system with a control loop that keeps the outlet pressure of the gas cabinet at a steady pressure regardless of either the pressure remaining in the gas cylinder, or the speed of consumption by the process tools (e.g., 305 of FIG. 3). The outlet pressure may be held steady at least down to the required supply pressure at the process tools. This system may provide one or more cost savings benefits. First, the gas cabinet 301 may be outfitted with regulators sized to deliver the required flow rates at much lower pressures without the fear of massive increases in outlet pressures due to the supply pressure effect of the regulator involved. Second, the gas cabinet 301 may now deliver gas to much higher flow applications. For example, a single gas cabinet may deliver gas to multiple valve manifold boxes. This may decrease the cost by avoiding use of multiple gas cabinets to perform the same tasks. Third, entities using the gas cabinet 301 may employ higher volume gas systems including, for example, 6-packs or bulkers. The costs of the cylinders may be minimized through the greater consumption of the residual gas in the cylinders, as well as volume purchasing of larger gas volumes.

In view of the systems and architectures described above, methodologies that may be implemented in accordance with the disclosed subject matter will be better appreciated with reference to the flow chart of FIG. 5. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 5 illustrates a flowchart of a method 500 for regulating pressure and/or flow within a system. The method 500 will now be described with frequent reference to the components and data of system 100 of FIG. 1.

Method 500 includes receiving an outlet pressure signal from a pressure transducer indicating a current level of system pressure (510). For example, controller 101 may receive outlet pressure signal 110 from a pressure transducer 109 or pressure switch. The outlet pressure signal 110 may indicate the current system pressure level 111 at a specific point within the system 100, or within the system in general.

Method 500 next includes comparing the current system pressure level to a specified desired system pressure level (520). The controller 101 may compare the current system pressure level 111 to a desired pressure level 103. This desired pressure level may be set by a machine operator, gas cabinet operator, gas cabinet manufacturer or owner or other user. The desired pressure level may be specific for each gas input or output line or may apply to the system 100 in general. For instance, if the gas cabinet had multiple gas input lines and multiple gas output lines, each gas line may have its own desired pressure level 103 which would be maintained by the system 100.

Then, upon determining that the current system pressure level 111 is above or below the desired system pressure level, method 500 includes sending an electrical current signal 108 to a current-to-pneumatic converter 106 that converts the electrical current signal to a pneumatic pressure signal 107 that is sent to a dome element 105 of a pneumatic pressure regulator 104 to raise or lower system pressure to the desired system pressure level (530). This desired system pressure level is then maintained via the control loop. If the pressure (or flow) level is too high or too low (e.g., outside of an acceptable deviation in system pressure level or flow), then the controller will receive an outlet pressure signal indicating that pressure has changed, and that the regulator 104 should be used to compensate for this change in pressure. Accordingly, at least in some embodiments, a user can simply set a desired pressure level, and the gas cabinet can maintain that pressure for much longer than in traditional systems. This allows more gas to be used before having to refill the gas containers, saving the owner both time and money.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A system for regulating pressure, comprising:
a controller;
a pneumatic pressure regulator that includes a dome configured to adjust pressure within the system;
a current-to-pneumatic converter configured to convert an electrical current signal to a pneumatic pressure signal; and
a pressure transducer arranged downstream from the pneumatic pressure regulator,
wherein the controller performs the following:
receives an outlet pressure signal from the pressure transducer indicating a current level of system pressure;
compares the current system pressure level to a specified desired system pressure level; and
upon determining that the current system pressure level is above or below the desired system pressure level, sends an electrical current signal to the current-to-pneumatic converter that converts the electrical current signal to a pneumatic pressure signal that is sent to the dome of the pneumatic pressure regulator to raise or lower system pressure to the desired system pressure level.

2. The system of claim 1, wherein the system comprises a gas cabinet for regulating gas pressure.

3. The system of claim 2, wherein the gas cabinet includes at least one gas input line and at least one gas output line.

4. The system of claim 2, wherein the system forms a control loop where outlet pressure from the gas cabinet is kept at a substantially steady pressure level.

5. The system of claim 4, wherein the control loop maintains the substantially steady pressure level regardless of pressure level remaining in a gas cylinder connected to the gas input line.

6. The system of claim 4, wherein the control loop maintains the substantially steady pressure level regardless of a speed of consumption by one or more process tools connected to the gas output line.

7. The system of claim 4, wherein the control loop maintains a substantially steady pressure level until supply pressure drops below a specified minimum supply pressure.

8. The system of claim 2, wherein the gas cabinet includes one or more regulators sized for the specified desired system pressure level.

9. The system of claim 1, wherein the controller sends the electrical current signal to the current-to-pneumatic converter upon determining that the pressure level is above the desired system pressure level by at least a specified amount or is below the desired system pressure level by at least a specified amount.

10. The system of claim 1, wherein the pressure transducer comprises a pressure switch.

11. A system for regulating flow, comprising:
a controller;
a pneumatic pressure regulator that includes a dome configured to increase flow or decrease flow within the system;
a current-to-pneumatic converter configured to convert an electrical current signal to a pneumatic pressure signal; and
a flow meter arranged downstream from the pneumatic pressure regulator,
wherein the controller performs the following:
receives a flow signal from the flow meter indicating a current level of system flow;
compares the current system flow level to a specified desired system flow level; and
upon determining that the current system flow level is above or below the desired system flow level, sends an electrical current signal to the current-to-pneumatic converter that converts the electrical current signal to a pneumatic pressure signal that is sent to the dome of the pneumatic pressure regulator to raise or lower system flow level to the desired system flow level.

12. The system of claim 11, wherein the system comprises a gas cabinet for regulating gas flow through at least one gas input line and through at least one gas output line.

13. The system of claim 12, wherein at least one of the gas input lines is connected to a gas cylinder.

14. The system of claim 12, wherein at least one of the gas output lines is connected to a process tool.

15. The system of claim 12, wherein the system forms a control loop where outlet gas flow from the gas cabinet is kept at a substantially steady system flow level.

16. The system of claim 15, wherein the control loop maintains the substantially steady system flow level regardless of pressure level remaining in a gas cylinder connected to a gas input line.

17. The system of claim 15, wherein the control loop maintains the substantially steady system flow level regardless of a speed of consumption by one or more process tools connected to a gas output line.

18. A method for regulating pressure, comprising:
receiving an outlet pressure signal from a pressure transducer indicating a current level of system pressure;
comparing the current system pressure level to a specified desired system pressure level; and
upon determining that the current system pressure level is above or below the desired system pressure level, sending an electrical current signal to a current-to-pneumatic converter that converts the electrical current signal to a pneumatic pressure signal that is sent to a dome element of a pneumatic pressure regulator to raise or lower system pressure to the desired system pressure level.

19. The method of claim 18, further comprising maintaining the desired system pressure level to within a specified acceptable deviation in system pressure level.

20. The implemented method of claim 18, wherein the method steps are performed by an embedded controller in a gas cabinet.
